(19) United States
(12) Patent Application Publication
(10) Pub. No.: US 2003/0204487 A1
(43) Pub. Date: Oct. 30, 2003

(54) A System of reusable components for implementing data warehousing and business intelligence solutions

(76) Inventors: Muni Kumar Sssv, (US); Indira Munjuluri, (US); Kiran N. Cavale, (US); Gautam Kar, (US); N. Satish Chandra, (US); Sayed Javed Ahmed, (US); Krishna G, (US)

Correspondence Address: VENABLE, BAETJER, HOWARD AND CIVILETTI, LLP, P.O. BOX 34385, WASHINGTON, DC, 20043-9998, US

(21) Appl. No.: 10/422,998

(22) Filed: Apr. 25, 2003

Related U.S. Application Data
(60) Provisional application No. 60/375,447, filed on Apr. 26, 2002.

(51) Int. Cl. G06F 7/00

(52) U.S. Cl. 707/1

(57) ABSTRACT

The present invention provides a system consisting of reusable components for implementing data warehousing and business intelligence solutions. The reusable components comprise a data model component housing an exhaustive pre-built vertical and business function specific data models and key performance indicator libraries. The reusable components further comprise a MetAL component which serves as a key repository of all mappings between all standard source data systems and vertical function specific data models and KPIs used in the data model component. Being compliant with Common Warehouse Metamodel, the system is extraction and reporting tool neutral. In other words, the technical and business metadata can be exported to any of the CWM compliant extraction and reporting tools. The system further consists of an algorithm to automatically detect version changes in the standard source systems.

The present invention relates to a system consisting of reusable components for implementing data warehousing (DW) and business intelligence (BI) solutions. The system is a combination of various components that would enable to have an access to the best practices as well as certain domain and business function specific data models, components, applications that enable building an integrated data warehousing (DW) and business intelligence (BI) infrastructure faster as well as enable their easy maintenance and support.

Further, the system provides an enriched framework which assists in applying certain unique concepts,experiences, philosophies and pre-packaged solutions to all its data warehousing and business intelligence engagements.

The data warehouse is a subject-oriented, integrated, time-variant, non-volatile collection of data used to support the strategic decision-making process for the enterprise. The data warehouse supports online analytical processing (OLAP), data mining and other statistical/analytical and related decision support applications, the functional and performance requirements of which are quite different from those of the online transactional processing (OLTP).

Thus, the unique combination of DW and BI addresses every requirement. The components play a very vital role in ensuring the achievement of objectives relating to DW and BI engagements.

The known systems available in the market such as Informatica Analytical Applications and Business Objects Application Foundation to just name a few. Informatica Analytical Applications offers pre-built data models for customer analytics, financial analytics, HR analytics and supply chain analytics. The system also offers the functionality of data integration and information delivery thorugh Informatica Power Centre and Informatica Power Analyser respectively, which are two separate products. Similarly, Business Objects Application Foundation is a framework for delivering analytical applications. It comes with pre-built matrices, business rules which enable various kinds of analysis apart from offering the functionality to perform predictive analysis and statistical process control.

The known systems however suffer from certain deficiencies.

1. They are products which need to be purchased.

2. These products are tied to their own extraction and information delivery tools, which means customers have to purchase these tools separately

3. These products do not come with pre-built data mappings with any of the standard data sources.

4. Lack of pre-built data mappings also means that any version changes in any of the standard data sources would require re-mapping the data sources with the target data models.

### OBJECTS OF THE INVENTION

An object of the present invention is therefore to provide a system to be utilised in DW and BI service engagements including plan, build and operate and across specialised service offerings.

Another object of the present invention is to enable DW and BI to build an asset base of reusable objects.

Yet another object of the present invention is to increase DW and BI engagement productivity.

A further object of the present invention is to ensure uniformity in approach to all DW and BI engagements.

Still another object of the present invention is to provide a structured channel for capturing engagement knowledge as well as to act as a self-reinforcing feedback loop.

Still further object of the present invention is to develop, test and incorporate applications that are necessary to plug gaps, in a cost effective manner, in the available set of tools and technologies.

### SUMMARY OF THE INVENTION

The system of the present invention using reusable components solves the, above deficiencies. The system uses reusable components consisting of pre-built vertical specific data models and key performance indications (KPIs) and pre-built maplets linking standard source systems to the vertical specific KPIs, to aid faster and cost effective implementation of data warehousing and business intelligence projects. While the system's data model component houses the vertical specific data models and KPIs, the metadata component houses the technical and business metadata along with the associated mappings. Being compliant with the common warehouse metamodel (CWM), the system is extraction and reporting tool neutral. In other words, the technical and business metadata can be exported to any of the CWM compliant extraction and reporting tools available in the market. It also consists of an algrorithm to automatically detect version changes in the standard source systems.

The system of the present invention seeks to solve the deficiences in the products available in the market in the following ways:

It is a royalty free framework for implementation of data warehousing and business intelligence projects, thereby eliminating the need to buy the product. The data models would remain with the customers after the implementation.

The metadata residing in the system can be exported to any common warehouse metamodel (CWM) compliant extraction or information delivery tool, thereby making the system tool neutral. The system can make use of the existing extraction or information delivery tool.

It comes with pre-built mappings between the fields in standard data sources and the pre-built data models and KPIs. The technical and business metadata of the standard data sources as well as the target KPIs are pre-mapped in the system, thereby eliminating the need to create mapping afresh.

The system comes along with an in-built algorithm to take care of version changes in the standard data sources.

Thus the present invention provides a system consisting of reusable components for implementing data warehousing (DW) and business intelligence (BI) solutions, said reusable components comprising a data model, component housing an exhaustive pre-built vertical and business function specific generic data models and key performance indicator (KPI) libraries; a MetAL component serving as a key repository of all mappings between all standard source data systems and vertical and function specific data models and KPIs housed in the data model component; and a component with the ability to export these mappings to any ETL and reporting tool, making it BI tool neutral and a platform neutral framework; thereby positioning itself as a technology neutral platform for organizations implementing data warehouses.

The data model component houses exhaustive pre-built vertical and business function specific generic data models and key performance indicator libraries.

The MetAL component serves as a key repository of all mappings between all standard source data systems and the vertical and function specific data models and KPIs, housed in the data model component.

The MetAL component contains the metadata of the various versions of all standard source systems and tie metadata of the pre-built data models and KPIs in CWM format. It also contains the associated mappings between these two sets of metadata.

Thus, the MetAL component has four different engines. The BI configuration engine houses the technical and business metadata of pre-built KPI libraries. The data sources engine of the MetAL component houses the technical and business metadata of the standard source systems. The integration engine contains the mappings between the metadata in the data sources engine and the metadata of the BI configuration engine. The mapping export engine exports the metadata to any extraction or information delivery tool.

Some of the additional features of these components are given below:

The data model component is provided with user interface for reconfiguring the data models and KPIs.

It is able to import/export data models using MS Excel

It reports for any given dimensional model

The data model component supports Star and Snow Flake schema. It also supports Oracle, SQL Server, DB2, Sybase, Teradata, Informix, SAP, PeopleSoft, Siebel, JDE, BaaN, MfgPro.

It is able to join set of dimensional models for an EDW.

The data model component provides access to best practices for time, name and address dimensions.

It provides guidelines for handling of slowing changing dimensions, rapidly changing small dimensions, monster dimensions, degenerate dimensions, junk dimensions.

The MetAL component is able to support the metadata for Oracle applications, SAP, PeopleSoft, Siebel, Oracle CRM, Vantive, Clarify, J D Edwards, BaaN, MfgPro.

It can export the mappings to ETL Tools-Oracle Warehouse Builder, Informatica, Sagent, SAS, Acta, Visual Datawarehouse Admininstrator, Abinitio, DTS, Data Junction.

The MetAL component is also able to export mappings to leading BI tools, packaged applications, CASE tools, database and system management tools.

It is able to bring into framework relational and non-relational databases RDBMS, File Systems, Dbase, Paradox, Btree.

The MetAL component is provided with user interface to construct source to target mappings.

The system stores its reusable components in the common warehouse metamodel framework, thereby positioning itself as a technology neutral platform for organizations implementing data warehouses.

### DETAILED DESCRIPTION OF THE INVENTION

The system of the present invention is provided in the form of an application which comprises the following components:

Data model component

MetAL component

Additionally, the system also constitutes certain add on applications having independent applications and which can be provided separately.

The data model component, a part of the overall system of the present invention, provides for access to pre-packaged data models, enable their reconfiguration as well as provide aids to dimensional modeling in the DW and BI context.

The data model component is organized across verticals and business functions across these verticals. The data model component of the system has the following additonal features:

Enable definitions of vertical and business function specific key performance measures (KBM)

Means to capture all the possible dimensions and their respective attributes/properties as well as establish mappings between the KBM and dimensions

Ability to generate data model based on definitions of dimensions, measures and analytical needs.

Built in dimensional models representing the best practices for enabling comprehensive analysis relating to particular business functions across verticals

User interface to reconfigure these standard data models

Ability to import/export data models using MS Excel

Ability to generate list of reports for a given dimensional model

Supports Star scheme and Snow Flake schema

Supports the following target databases oracle, SQL Server, DB2, Sybase, Teradata, Informix Redbrick among others.

Ability to join set of dimensional models for an EDW

Best practices for time, name and address dimensions

Provides guidelines for handling of slowly changing dimensions, rapidly changing small dimensions, monster dimensions, degenerate dimensions, junk dimensions.

The list of in-built data models currently available in the data model component is given in Table 1.

TABLE 1

| | Strategic/ | | | | | |
|---|---|---|---|---|---|---|
| | Corporate | Sales & | | | | |
| Function → | Managment/ | Marketing & | | | | |
| ↓ | Other | After Sales | Accounting & | Human | | |
| Domain | Analytics | Service | Finance | Resources | Procurement | Operation |
| Manufacturing | CPM | Sales & | Financial | HR | Materials | Production |
| | | Distribution, | | | Management | Planning & |
| | | CRM | | | | Control |
| Financial | CPM, Claim | Sales & | Financial | HR | Materials | Production |
| Services | Analysis, Risk | Distribution, | | | Managment | Planning & |
| | Analysis, | CRM | | | | Control |
| | Credit Card | | | | | |
| | Analysis, | | | | | |
| | Fraud | | | | | |
| | Detection | | | | | |
| Telecom | CPM, Call | Sales & | Financial | HR | Materials | Operational |
| | Analysis, | Distribution, | | | Managment | Planning |
| | Churn | CRM | | | | |
| | Managment, | | | | | |
| | Fraud | | | | | |
| | Detection | | | | | |
| Retail | CPM | Sales & | Financial | HR | Materials | Production |
| | | Distribution | | | Managment | Planning & |
| | | CRM | | | | Control |
| transportation | CPM | Sales & | Financial | HR | Materials | Fleet |
| | | Distribution | | | Managment | Managment |
| | | CRM | | | | |
| Utilities | CPM | Sales & | Financial | HR | Materials | Production |
| | | Distribution | | | Managment | Planning & |
| | | CRM | | | | Control |
| Automotive | CPM | Sales & | Financial | HR | Materials | Production |
| | | Distribution | | | Managment | Planning & |
| | | CRM | | | | Control |
| Healthcare | CPM | Sales & | Financial | HR | Materials | Production |
| | | Distribution | | | Managment | Planning & |
| | | CRM | | | | Control |
| Public Sector | CPM | Sales & | Financial | HR | Materials | Production |
| | | Distribution | | | Managment | Planning & |
| | | CRM | | | | Control |
| Computer & | CPM | Sales & | Financial | HR | Materials | Production |
| Technology | | Distribution | | | Managment | Planning & |
| | | CRM | | | | Control |
| Electronic | CPM | Sales & | Financial | HR | Materials | Production |
| Commerce | | Distribution | | | Managment | Planning & |
| | | CRM | | | | Control |
| Energy | CPM | Sales & | Financial | HR | Materials | Production |
| | | Distribution | | | Managment | Planning & |
| | | CRM | | | | Control |
| Enviroment | CPM | Sales & | Financial | HR | Materials | Production |
| | | Distribution | | | Managment | Planning & |
| | | CRM | | | | Control |
| Media & | CPM | Sales & | Financial | HR | Materials | Production |
| Entertainment | | Distribution | | | Managment | Planning & |
| | | CRM | | | | Control |

The MetAl component, a part of the system of the present invention, provides for acquisition, maintenance and movement of metadata to and from various architecture components in the enterprise. This component provides for a MetAl database—a central, shared source of metadata including prepackaged metadata—enabling reduction in implementation and maintenance costs and thereby helping customers get more value.

The MetAl component of the system has the following additional features:

Ability to capture the metadata of different versions of enterprise applications, including business metadata, and store in CWM format. Current set of enterprise applications supported include oracle applications, SAP, PeopleSoft, Siebel, Oracle CRM, Vantive, Clarify, J D Edwards, BaaN, Mfg Pro.

Ability to establish, capture and store metadata source to target mappings. Currently the MetAL component has information of pre-built mappings for all the data models listed in earlier para to all the enterprise applications listed in earlier para.

Ability to export the mappings to the following ETL Tools Oracle Warehouse Builder, Informatica, Sagent, SAS, Acta, Visual Datawarehouse Administrator, Abinitio, DTS, Data Junction.

Ability to bring into framework relational and non-relational databases RDBMS, File Systems, Dbase, Paradox, Btree.

User interface to construct source to target mappings.

Ability to enable mappings between any combination of data stores

Metadata in CWM compliant format

Enable the exchange of metadata across the following tool categories as well as between the following tool categories:

Data movement tools that transform and integrate disparate data types and move data reliably to the warehouse.

Business intelligence tools that provide end-user access and analysis for making business decisions.

Business applications that provide packaged warehouse solutions for specific markets

CASE tools

Database and systems management tools

The data warehousing and business intelligence implementation methodology is a unique full life-cycle methodology for implementation of data warehousing and business intelligence solutions covering all the phases. The DW and BI methodology provides for a structured and uniform approach to all DW and BI engagements as well as encapsulates the best practices and unique approach/philosophy towards such engagements. It is a unique methodology (defined series of steps) for implementation and maintenance of data warehousing projects. The methodology is carried out in five stages including requirements analysis, design, development, deployment and maintenance and support.

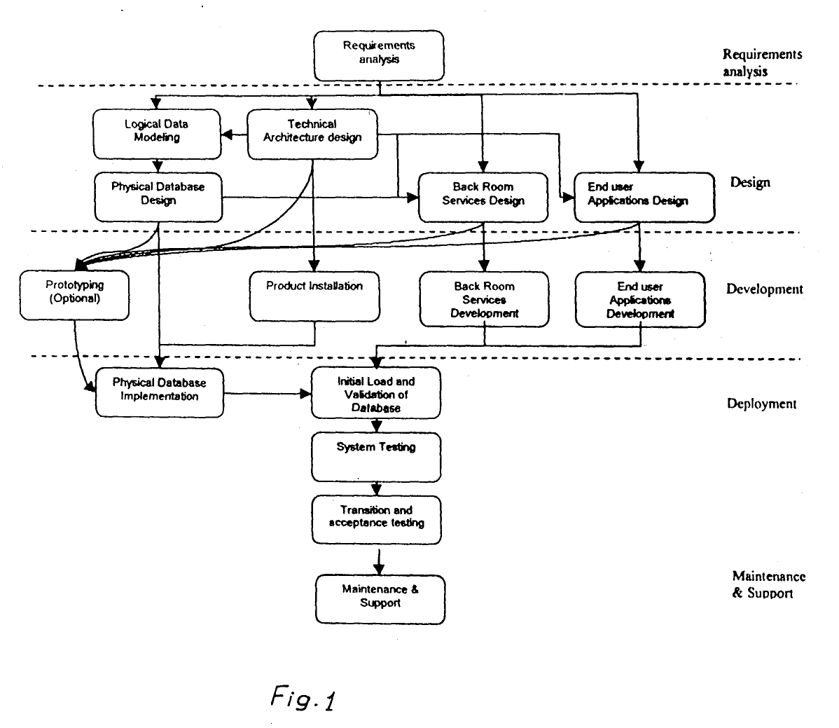

The process flow chart for the implementation methodology is shown in FIG. 1.

Requirement analysis stage consists of collecting the requirements from the business users and IT users in the organization mainly through interviews. Analysis is done on the critical success factors, existing business processes, source data, IT infrastructure, and reporting needs, and the requirments are documented and prioritized.

The design stage consists of the following activities. (The logical data modeling and physical database designing are executed in sequence. The other activities are executed more or less in parallel with overlaps/staggered start of activities. Normally back room processes design and end user applications design are taken up after technical architecture and database designing have progressed enough to give inputs to these).

Technical architecture of the solution is defined based on the user requirements and the information about the existing infrastructure. Following are defined as part of the technical architecture:

Data Warehouse technical architecture

Capacity plan

Evaluation criteria for products

Product recommendations

Back up and recovery strategy

Security strategy

Metadata collection strategy

Performance benchmarks for the solution

A conceptual data model is first developed based on analysis of source data and the requirements. From the conceptual data model, the logical data models for the staging area, ODS, data marts/data warehouse are created as required.

Physical database design focuses on defining the physical structures necessary to support the logical data model. Primary elements of this stage involve defining naming standards and setting up the database environment. Preliminary indexing and partition strategies are also determined.

The back room services include the extraction, transformation and loading services, metadata services, and warehouse administration services, if any. This stage involves design/customization of all back room processes/tools.

The back room services design includes:

ETL, metadata and warehouse administration process design

Source to target mapping

Prioritizing ETL activities

Strategies for data quality

Automation of the ETL processes

Developing program specifications

The end user application (front room) design involves design/customization of all data access components/tools (end user applications), screens and reports.

End user application design involves:

Identification and prioritization of reports

End user application modules and processes

Coding and GUI standards

Report and screen specifications

Program specifications (if required)

Interface with external systems

The development stage consists of the following activities:

Back room services development activity involves coding/scripting for all the back room services including the ETL processes and warehouse administration processes. Alternately, if any tool from the market need to be used for extraction and transformation/scrubbing/cleansing,customization of the same is carried out.

In the end user applications development stage, the end user applications are developed by configuring the data access tools and/or developing screens and reports. Administrative modules, if any, are also developed in parallel.

Product installation involves installation and testing all hardware and software including ETL tools, servers (DB/application/web), DBMS, data access tools, metadata management tools etc.

Creation and testing of a prototype of the solution. The scope and nature of the prototype is decided in the requirement analysis stage.

Prototyping involves:

Defining the scope for the prototype

Define acceptance cirteria for the prototype

Create test cases

Develop the prototype

Review and test the prototype

The deployment stage consists of the following activities:

Creation of the physical databases for the operational data store/data mart/data warehouse. Deployment of the backroom and front room applications (custom-developed) is also done in this stage.

Initial load and validation of the database comprising the extraction, transformation and loading processes are executed for the initial load of the data warehouse; data validation is done against the pre-defined data quality norms to ensure the completeness and correctness of data loaded.

System tests are conducted as per the System Test plan, and covering the entire application.

System test includes:

Volume testing

Stress testing

Configuration testing

Security testing

Installability testing

Documentation testing

Performance testing

Usability testing

In the transition stage, the complete solution is handed over to the customer after acceptance tests and user training.

Transition involves:

Developing user training material

Setting up user access and security privileges

Conducting user training

Handing over user documentation

Performing acceptance testing

Completion of hand-over

In the user training stage:

user training needs are identified during requirement analysis stage

training is cutomized for different levels/types of users (administrators, IT personnel, business users etc.)

efforts involved in training are planned in advance

training materials are prepared during the design and development stages

training plans are made and training is performed as per the plan

training effort is allocated

training is conducted as per the plan, and monitoring is done to ensure effective training

at least one “owner” is to be designated for each subject area to interact and coordinate with the development team

involvement of business users and IT staff in providing inputs on existing business processes, infrastructure, and analytical/reporting needs in the requirement analysis stage

QCB personnel may be required to spend time in reviewing/approving certain deliverables as per the review plan

conducting acceptance test.

The DW and BI methodology has the following features:

Detailed reference material on the phases, tasks, activities and all relevant templates

Detailed aids, guidelines and best practices reflecting experience, expertise and philosophy relating to such engagements. These would be especially useful in stages relating to technical architecting, dimensional modeling, choice of tools, technologies and approaches, etc.

Enable systematic documentation relating to the engagement, structured storage and provide for its import and/or export across locations

Audit trail and configuration management

The unique methodology supports the generic and specialized solution offersings shown in Table 2.

TABLE 2

| Generic Solution Offerings | | | | | |
|---|---|---|---|---|---|
| Plan | Build | Operate | Specialized Solution Offerings | | |
| Need | Rapid | Web | Data | Data Mining | ERP/CRM |
| Analysis | Prototyping | Enabling | Warehousing | | Intelligence |
| RFP | Customization | Maintenance | Strategic | Enterprise | E-Business |
| Preparation | | & Migration | Enterprise | Marketing | Intelligence |
| | | | Management | Automation | |
| Solution | Implementation & | Performance | Analytical | Campaign | |
| Architecting | Integration | Tuning | CRM | Management | |

Data warehousing and business intelligence engagements identified gaps with respect to availability of appropriate tools and technologies vis-à-vis certain specific requirements. As part of this philosophy to constantly enrich the base of reusable components, the following add on applications can be included in the system of the present invention.

Desktop version can be installed on PCs as well as laptops. The desktop application can work in stand-alone mode. The data can be extracted from a relational database or flat files into the desktop PC so that the user can work on the data independently without connecting to the corporate data warehouse or data mart. The administrator of this application just needs to plug the model into the application and this model is then available to the end user for his analysis needs.

The web verison of the product gives access to users from any location within the company via the intranet or even over the internet. Any version updates can be replicated for all users by updating the application only at the server, thereby eliminating the need for version updates at different user locations. Also the model can be plugged into the application only on the application server and the model is then available to all users for their analysis needs. The web verison can extract data from XML files apart from any relational database or flat files.

Currently this application architecture contains two layers.

Application process layer—actual process layer

Model building layer—external (plug-in)

Application process layer contains the following tiers

Client tier

Web/business tier

Information tier

The model building layer performs the following processes

Data preparation

Data exploration

Model generation

Model interpretation

Model and MainDataSet deployment

This architecture is highly modularized for easy maintenance. The desktop version of the product contains the following modules.

Authentication module

Control module

GUI module

Model module

Visualization module

Apps module

Criteria module

Exception module

Metapack module

Util module

A data mining application Is used for prediction, analysis and visualization. It uses algorithm models built by using data mining tools such as oracle Darwin, SAS E-miner, SPSS Clementine. These models are ‘plugged’ into the application and used for prediction, analysis and visualization. The product comes in two versions, one for desktop users and another web based version.

There are several data mining applications available in the market. But the primary deficiency is that it does not differentiate between expert users and the ordinary business users. The data modeling component involving complex statistical techniques and the query and visualization component, which helps in interpreting the results are tied together, thereby making the analysis a difficult proposition for the ordinary users.

Off-line analysing and processing involves providing for information anytime, anywhere. It is an application, which provides for multi-dimensional analysis of the data in stand-alone mode without connecting to the server, transmission of reports via multiple communication channels (push mechanism) to the user and sharing of analytical business data with business partners without compromising on security.

From the foregoing description, it should be undestood that the description is made by way of example only and that the invention should not be understood as limited to the particular embodiments described herein. It is also to be understood that various modifications, rearrangements and substitutions can be made by one skilled in the art without departing from the scope and spirit of the invention.

What is claimed is:

1. A system consisting of reusable components for implementing data warehousing (DW) and business intelligence (BI) solutions, said reusable components comprising:
a data model component housing an exhaustive pre-built vertical and business function specific generic data models and key performance indicator (KPI) libraries;
a MetAL component serving as the key repository of all mappings between all standard source data systems and vertical and function specific data models and KPIs housed in the data model component; and
a component with the ability to export these mappings to any ETL and reporting tool, making it BI tool neutral and a platform neutral framework; thereby positioning itself as a technology neutral platform for organizations implementing data warehouses.

2. A system consisting of reusable component for implementing data warehousing (DW) and business intelligence (BI) solutions, said reusable component comprising a data model housing an exhaustive pre-built vertical and business function specific generic data models and key performance indicator (KPI) libraries;
said data model component being provided with a user interface to reconfigure the data models and KPIs.

3. The system of claim 2, wherein said data model component is capable of importing/exporting data models using MS Excel.

4. The system of claim 3, wherein the data model component reports for any given dimensional model.

5. The system of claim 2, wherein the data model supports Star and Snow Flake schema.

6. The system of claim 2, wherein the data model component supports Oracle, SQL Server, DB2, Sybase, Teradata, Informix, SAP, PeopleSoft, Siebel, JDE, BaaN and Mfg Pro.

7. The system of claim 2, wherein the data model component is capable of joining set of dimensional models for an EDW.

8. The system of claim 2, wherein the data model component provides access to best practices for time, name and address dimensions.

9. The system of claim 2, wherein the data model component provides guidelines for handling of slowly changing dimensions, rapidly changing small dimensions, monster dimensions, degenerate dimensions, junk dimensions.

10. A system consisting of reusable component for implementing data warehousing (DW) and business intelligence (BI) solutions, said reusable component comprising a MetAL component serving as a key repository of all mappings between all standard source data systems and vertical and function specific data models and KPIs housed in the data model component;
said MetAL component supports the metadata for Oracle Applications, SAP, PeopleSoft, Siebel, Oracle, CRM, Vantive, Clarify, J D Edwards, BaaN, Mfg Pro.

11. The system of claim 10, wherein the MetAL component is capable of bringing into framework relational and non-relational databases RDBMS, File Systems, Dbase, Paradox, Btree.

12. A system consisting of reusable component for implementing data warehousing (DW) and business intelligence (BI) solutions, said reusable component comprises a MetAL component serving as a key repository of all mappings between all standard source data systems and vertical and function specific data models and KPIs housed in the data model component, said MetAL component having the ability to export the mappings to ETL Tools-Oracle Warehouse Builder, Informatica, Sagent, SAS, Acta, Visual Datawarehouse Administrator, Abinitio, DTS, Data Junction.

13. The system of claim 12, wherein the MetAL component exports the mapping to leading BI tools, packaged applications, CASE tools, database and system management tools.

14. The system of claim 12, wherein the user interface is provided to construct the source to target mappings.

15. A method for implementation and maintenance of projects comprising the the steps of:
analysing the critical success factors;existing business processes, source data, IT infrastructure and reporting needs after collecting required information from business users and IT users;
designing in sequence the logical data modeling and physical database;
developing back room services end user applications, product installation and total time;
deploying physical data base implementation, initial load and validation of the data base, system testing, transition and user training; and
maintaining and supporting the system.

16. A system consisting of reusable components for implementing data warehousing (DW) and business intelligence (BI) solutions substantially as herein described.
